(19) United States
(12) Patent Application Publication
(10) Pub. No.: US 2018/0187004 A1
(43) Pub. Date: Jul. 5, 2018

(54) Resin Compositions and Articles Using the Same

(71) Applicant: Lotte Advanced Materials Co., Ltd., Yeosu-si (KR)

(72) Inventors: Heeyun JEONG, Uiwang-si (KR); Jungeun PARK, Uiwang-si (KR); Keehae KWON, Uiwang-si (KR)

(21) Appl. No.: 15/855,103

(22) Filed: Dec. 27, 2017

(30) Foreign Application Priority Data
Dec. 29, 2016 (KR) 10-2016-0182671

(51) Int. Cl. C08L 69/00

(52) U.S. Cl. CPC C08L 69/00

(57) ABSTRACT

Disclosed are a resin composition including a base resin consisting of (A) a polycarbonate resin and (B) a polybutylene terephthalate resin; (C) a (meth)acryl-based copolymer; and (D) high structured carbon black, and an article manufactured therefrom.

### CROSS-REFERENCE TO RELATED APPLICATION

This application claims priority to and the benefit of Korean Patent Application No. 10-2016-0182671 filed in the Korean Intellectual Property Office on Dec. 29, 2016, the entire disclosure of which is incorporated herein by reference.

### FIELD

Resin compositions and articles using the same are disclosed.

### BACKGROUND

Polycarbonate (PC) resins can have excellent impact resistance and mechanical properties and also high transparency, excellent dimensional stability, extensive coloring properties, and the like and thus are widely used for housings of electrical/electronic products, auto interior/exterior parts, and the like.

Auto exterior parts can be treated through a painting process in order to develop a highly glossy product. Painting processes, however, can require several steps, have a high defect rate, generate a harmful volatile component at a high rate, be expensive, and the like, and accordingly, a non-painted material is being developed.

A polymethylmethacrylate (hereinafter, referred to as ‘PMMA’) resin or a PMMA/IR (impact resistant rubber) resin has been used in exterior parts. The PMMA resin, however, can have very low impact strength, and thus there is still a need for a non-painted thermoplastic resin having excellent weather resistance and impact resistance.

Polycarbonate (PC) resin and polybutylene terephthalate (PBT) resin compositions have also been used for auto exterior parts. This thermoplastic resin composition can have excellent hardness. PC/PBT resin compositions, however, can lack impact resistance and skin match characteristics, and can be discolored due to deterioration of weather resistance. Accordingly, there is a need for a non-painted resin composition maintaining excellent weather resistance and simultaneously having impact resistance.

### SUMMARY

An embodiment provides a resin composition that can have improved impact resistance and weather resistance.

Another embodiment provides an article manufactured from the resin composition.

In an embodiment, a resin composition includes a base resin consisting of (A) a polycarbonate resin and (B) a polybutylene terephthalate resin; (C) a (meth)acryl-based copolymer; and (D) high structured carbon black.

The high structured carbon black may be included in an amount of about 0.1 parts by weight to about 5 parts by weight based on about 100 parts by weight of the base resin consisting of the polycarbonate resin and the polybutylene terephthalate resin.

The high structured carbon black may be included in an amount of about 0.1 parts by weight to 1 part by weight based on about 100 parts by weight of the base resin consisting of the polycarbonate resin and the polybutylene terephthalate resin.

An average particle diameter of primary carbon black particles of the high structured carbon black may be about 15 nm to about 25 nm.

The (meth)acryl-based copolymer may include a methylmethacrylate-butadiene-styrene copolymer.

The (meth)acryl-based copolymer may be included in an amount of about 1 part by weight to about 10 parts by weight based on about 100 parts by weight of the base resin consisting of the polycarbonate resin and the polybutylene terephthalate resin.

The base resin may include about 50 wt % to about 70 wt % of the polycarbonate resin and about 30 wt % to about 50 wt % of the polybutylene terephthalate resin.

According to another embodiment, an article manufactured from the resin composition is provided.

The article may have an Izod impact strength of greater than or equal to about 70 kgf·cm/cm measured on a ⅛″-thick specimen according to ASTM D256.

The article may have a color difference (dE) of less than or equal to about 6 between before and after exposure under a Method A condition according to ISO 4892-2 for 1,500 hours.

The resin composition according to an embodiment may have improved impact resistance and/or weather resistance.

### DETAILED DESCRIPTION

The present invention will be described more fully hereinafter, in which exemplary embodiments of the present invention are discussed. This invention may, however, be embodied in many different forms and should not be construed as limited to the exemplary embodiments set forth herein. These exemplary embodiments disclosed in this specification are provided so that this disclosure will satisfy applicable legal requirements.

As used herein, when a specific definition is not otherwise provided, the term “substituted” refers to one substituted with a substituent selected from a halogen (F, Cl, Br, or I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof, instead of at least one hydrogen.

As used herein, when a specific definition is not otherwise provided, the term “hetero” refers to at least one heteroatom selected from N, O, S and/or P in a Chemical Formula.

Hereinafter, a resin composition according to an embodiment is described.

A resin composition according to an embodiment provides a resin composition including a base resin consisting of (A) a polycarbonate resin and (B) a polybutylene terephthalate resin; (C) a (meth)acryl-based copolymer; and (D) high structured carbon black.

In general, the carbon black may play a role of applying a shield effect to the resin composition and thus preventing weather resistance of the resin composition from being deteriorated by UV and the like as well as work as a colorant for realizing a black color. However, when a conventional carbon black is applied to the resin composition, the resin composition has a decreased shielding force due to an agglomeration phenomenon of the carbon black and thus has a problem of deteriorated weather resistance and impact resistance.

In contrast, the resin composition according to exemplary embodiments includes high structure carbon black and thus may exhibit excellent weather resistance due to a shield effect as well as maintain excellent impact resistance due to excellent dispersibility of the carbon black despite increasing an amount of the carbon black.

In other words, the resin composition according to exemplary embodiments includes high structure carbon black and thus may have improved weather resistance as well as includes a polycarbonate resin and a polybutylene terephthalate resin as a base resin and thus may have excellent impact resistance at room temperature and a low temperature.

Hereinafter, each component of the resin composition is described in more detail.

(A) Polycarbonate Resin

A polycarbonate resin according to embodiments may be prepared by reacting one or more diphenols represented by Chemical Formula 1 with phosgene, halogenic acid ester, carbonate ester, or a combination thereof:

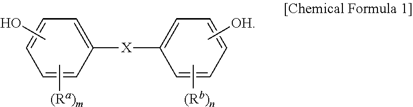

In Chemical Formula 1,

X is selected from a single bond, a substituted or unsubstituted C1 to C5 alkylene, a substituted or unsubstituted C1 to C5 alkylidene, a substituted or unsubstituted C3 to C6 cycloalkylene, a substituted or unsubstituted C5 to C6 cycloalkylidene, —CO, S, and SO₂,

R^{a} and R^{b} are the same or different and are each independently a substituted or unsubstituted C1 to C30 alkyl group or a substituted or unsubstituted C6 to C30 aryl group, and

m and n are the same or different and are each independently 0 to 4.

A diphenol represented by Chemical Formula 1 may be used singly or two or more kinds of diphenols represented by Chemical Formula 1 may be combined to constitute a repeating unit of a polycarbonate resin.

Examples of the diphenols may include without limitation 4,4′-dihydroxydiphenyl, 2,2-bis(4-hydroxyphenyl)propane (referred to as ‘bisphenol-A’), 2,4-bis(4-hydroxyphenyl)-2-methylbutane, bis(4-hydroxyphenyl)methane, 1,1-bis(4-hydroxyphenyl)cyclohexane, 2,2-bis(3-methyl-4-hydroxyphenyl)propane, 2,2-bis(3-chloro-4-hydroxyphenyl)propane, 2,2-bis(3,5-dimethyl-4-hydroxyphenyl)propane, 2,2-bis(3,5-dichloro-4-hydroxyphenyl)propane, 2,2-bis(3,5-dibromo-4-hydroxyphenyl)propane, bis(4-hydroxyphenyl)sulfoxide, bis(4-hydroxyphenyl)ketone, bis(4-hydroxyphenyl)ether, and the like, and mixtures thereof. For example, 2,2-bis(4-hydroxyphenyl)propane, 2,2-bis(3,5-dimethyl-4-hydroxyphenyl)propane, 2,2-bis(3,5-dichloro-4-hydroxyphenyl)propane, and/or 1,1-bis(4-hydroxyphenyl)cyclohexane, for example, 2,2-bis(4-hydroxyphenyl)propane (bisphenol-A), may be used.

The polycarbonate resin may be a linear polycarbonate resin, a branched polycarbonate resin, and/or a polyestercarbonate copolymer resin.

The polycarbonate resin may have a weight average molecular weight (Mw) from about 10,000 g/mol to about 100,000 g/mol, for example, about 15,000 g/mol to about 50,000 g/mol, and as another example, about 15,000 g/mol to about 35,000 g/mol, but is not limited thereto. At least two different polycarbonate resins having different weight average molecular weights may be mixed in order to satisfy desired fluidity.

The base resin may include the polycarbonate resin in an amount of about 50 wt % to about 70 wt %, for example, about 60 wt % to about 70 wt %, based on a total amount (total weight, 100 wt %) of the base resin consisting of the polycarbonate resin and the polybutylene terephthalate resin. In some embodiments, the base resin may include the polycarbonate resin in an amount of about 50, 51, 52, 53, 54, 55, 56, 57, 58, 59, 60, 61, 62, 63, 64, 65, 66, 67, 68, 69, or 70 wt %. Further, according to some embodiments, the amount of the polycarbonate resin may be in a range from about any of the foregoing amounts to about any other of the foregoing amounts.

When the polycarbonate resin is included in an amount within the above ranges, a resin composition having improved impact resistance may be provided.

(B) Polybutylene Terephthalate Resin

A resin composition according to embodiments includes a polybutylene terephthalate resin. The polybutylene terephthalate resin is a kind of an aromatic polyester resin and is a condensation-polymerized polymer obtained through a direct ester reaction and/or an ester exchange reaction of a 1,4-butanediol monomer and a terephthalic acid and/or dimethyl terephthalate monomer.

To increase the impact resistance, the polybutylene terephthalate resin may be copolymerized and/or mixed with polytetramethylene glycol (PTMG), polyethylene glycol (PEG), polypropylene glycol (PPG), a low molecular weight aliphatic polyester, and/or an aliphatic polyamide, and/or may be used in the form of a modified polybutylene terephthalate resin obtained by blending polybutylene terephthalate with an impact-reinforcing agent.

The polybutylene terephthalate resin may have intrinsic viscosity [η] of about 0.5 dl/g to about 1.5 dl/g, for example, about 1.0 dl/g to about 1.3 dl/g measured using an o-chloro phenol solvent at 25° C. When the intrinsic viscosity of the polybutylene terephthalate resin is within the above ranges, mechanical strength and/or formability can be improved.

The base resin may include the polybutylene terephthalate resin in an amount of about 30 wt % to about 50 wt %, for example about 30 wt % to about 40 wt %, based on a total amount (total weight, 100 wt %) of the base resin consisting of the polycarbonate resin and the polybutylene terephthalate resin. In some embodiments, the base resin may include the polybutylene terephthalate resin in an amount of about 30, 31, 32, 33, 34, 35, 36, 37, 38, 39, 40, 41, 42, 43, 44, 45, 46, 47, 48, 49, or 50 wt %. Further, according to some embodiments, the amount of the polybutylene terephthalate resin may be in a range from about any of the foregoing amounts to about any other of the foregoing amounts.

When the polybutylene terephthalate resin is included in an amount within the above ranges, a resin composition having improved impact resistance and/or weather resistance may be provided.

(C) (Meth)acryl-Based Copolymer

The (meth)acryl-based copolymer according to embodiments is a copolymer including a (meth)acryl-based compound as a copolymerization monomer and plays a role of an impact-reinforcing agent.

For example, the (meth)acryl-based copolymer may be a copolymer including methyl methacrylate as a repeating unit. For example, the (meth)acryl-based copolymer may include a methylmethacrylate-butadiene-styrene copolymer (MBS).

The resin composition may include the (meth)acryl-based copolymer in an amount of about 1 to 10 parts by weight, for example, about 1 to 8 parts by weight, and as another example, about 2 to 8 parts by weight, based on about 100 parts by weight of the base resin consisting of the polycarbonate resin and the polybutylene terephthalate resin. In some embodiments, the resin composition may include the (meth)acryl-based copolymer in an amount of about 1, 2, 3, 4, 5, 6, 7, 8, 9, or 10 parts by weight. Further, according to some embodiments, the amount of the (meth)acryl-based copolymer may be in a range from about any of the foregoing amounts to about any other of the foregoing amounts.

When the (meth)acryl-based copolymer is included in an amount within the above ranges, a resin composition having improved impact resistance may be provided.

(D) High Structured Carbon Black

The resin composition according to an embodiment includes high structured carbon black. In the high structured carbon black, high structure refers to branched-structured agglomeration of carbon black primary particles. High structured carbon black is known in the art, and the meaning of the term high structured carbon black is well understood by the skilled artisan.

The carbon black primary particles that make up the high structured carbon black may have an average particle diameter (D50) of about 15 nm to about 25 nm, for example, an average particle diameter of about 15 nm to about 20 nm.

The agglomerated carbon black primary particles of high structured carbon black may have an average size (the longest distance between carbon black primary particles in agglomeration) of about 0.1 μm to 3 μm, for example, an average size of about 0.5 μm to 2 μm.

The resin composition may include the high structured carbon black in an amount of about 0.1 to 5 parts by weight, for example, about 0.1 to 3 parts by weight, and as another example, about 0.1 to 1 part by weight, based on about 100 parts by weight of the base resin consisting of the polycarbonate resin and the polybutylene terephthalate resin. In some embodiments, the resin composition may include the high structured carbon black in an amount of about 0.1, 0.2, 0.3, 0.4, 0.5, 0.6, 0.7, 0.8, 0.9, 1, 2, 3, 4, or 5 parts by weight. Further, according to some embodiments, the amount of the high structured carbon black may be in a range from about any of the foregoing amounts to about any other of the foregoing amounts.

When the high structured carbon black is included in an amount within the above range, a resin composition having excellent impact resistance and/or excellent weather resistance may be provided.

The resin composition according to embodiments may include at least one additive in order to impart and/or improve a property and/or a balance of properties, such as but not limited to improving injection molding. Examples of the other additives may include without limitation surfactants, nucleating agents, coupling agents, fillers, plasticizers, lubricants, antibacterial agents, release agents, antioxidants, inorganic material additives, colorants, lubricants, antistatic agents, pigments, dyes, flame retardants, ultraviolet (UV) stabilizers, and the like, and may be used alone or in a combination of two or more.

The other additives may be included in an amount of about 0.1 to 15 parts by weight based on about 100 parts by weight of the base resin consisting of the polycarbonate resin and the polybutylene terephthalate resin.

In another embodiment, an article manufactured from the resin composition is provided. The article may be manufactured in various methods known in the related art, for example, injection molding, blow molding, extrusion, and the like by using the resin composition. The article can include a large part such as an auto part and/or an injection molded product having a complex shape but is not limited thereto.

The article can exhibit excellent impact resistance and/or weather resistance. For example, the article may have an Izod impact strength of greater than or equal to about 70 kgf·cm/cm, for example, greater than or equal to about 72 kgf·cm/cm, measured on a ⅛″-thick specimen according to ASTM D256.

In addition, the article may have a color difference (dE) of less than or equal to about 6, for example less than or equal to about 5 between before and after exposure under a Method A condition according to ISO 4892-2 for 1,500 hours.

### EXAMPLES

Hereinafter, the present disclosure is illustrated in more detail with reference to examples and comparative examples. However, the following examples and comparative examples are provided for the purpose of illustration only and the present invention is not limited thereto.

The components used for preparing resin compositions in examples and comparative examples are as follows.

(A) Polycarbonate Resin

A bisphenol-A type polycarbonate resin (Samyang Corporation, TRIREX 3025PJ) having a weight average molecular weight of 28,000 g/mol is used.

(B) Polybutylene Terephthalate Resin

A polybutylene terephthalate resin (Shinkong Synthetic Fibers Corp., SHINITE DHK011) having intrinsic viscosity [η] of 1.2 dl/g measured using an o-chloro phenol solvent at 25° C. is used.

(C) (Meth)acryl-Based Copolymer

A methylmethacrylate-butadiene-styrene copolymer (MRC Inc, METABLEN C-223A) is used.

(D) Carbon Black

(D-1) Low structured carbon black (Orion engineered carbons, HI BLACK 50 L) is used.

(D-2) High structured carbon black (Orion engineered carbons, HIBLACK 40132) is used.

### Examples 1 to 3 and Comparative Examples 1 to 4

The components are used to prepare each resin composition according to Examples 1 to 3 and Comparative Examples 1 to 4 to respectively have the compositions shown in Table 1. According to the manufacturing method, each component is mixed to have the compositions shown in Table 1 and then, extruded with a general twin-screw extruder at 250° C. to 300° C. to manufacture resin compositions in a pellet form. The manufactured pellets are dried at 80° C. for 5 hours or more and are injection-molded into specimens for evaluating properties using a 150 ton screw-type injector under a temperature condition of 240° C. to 280° C.

TABLE 1

| | | | | | Comp. | Comp. | Comp. | Comp. |
|---|---|---|---|---|---|---|---|---|
| | | Ex. 1 | Ex. 2 | Ex. 3 | Example 1 | Example 2 | Example 3 | Example 4 |
| (A) (wt %) | | 60 | 70 | 60 | 60 | 70 | 60 | 70 |
| (B) (wt %) | | 40 | 30 | 40 | 40 | 30 | 40 | 30 |
| (C) (parts by weight) | | 8 | 6 | 4 | 8 | 6 | 4 | 8 |
| (D) (parts by | (D-1) | — | — | — | 1 | 1 | 2 | 2 |
| weight) | (D-2) | 1 | 1 | 0.5 | — | — | — | — |

(parts by weight: parts by weight based on 100 parts by weight of the polycarbonate resin (A) and the polybutylene terephthalate resin (B))

### Evaluation of Properties

Properties of the specimens manufactured in Examples 1 to 3 and Comparative Examples 1 to 4 are evaluated, and the results are shown in Table 2.

(1) Impact resistance (kgf·cm/cm): Izod impact strength is measured by forming a notch on ⅛″-thick specimens according to an evaluation method of ASTM D256.

(2) Weather Resistance: A color difference dE between before and after exposure under a Method A condition according to ISO 4892-2 for 1,500 hours is calculated according to Equation 1 after calculating dL, da, and db.

dE=\sqrt{(dL)²+(da)²+(db)²} [Equation 1]

where dL is a difference (L₁−L₀) between L values before/after exposure testing; da is a difference (a₁−a₀) between a values before/after exposure testing; and db is a difference (b₁−b₀) between b values before/after exposure testing, in which L₀, a₀ and b₀ are initial color values, as measured on an injection molded specimen having a size of 50 mm×90 mm×3 mm with a Konica Minolta CM-3700D color-difference meter under a SCE (specular component excluded) condition, and L₁, a₁ and b₁ are color values, as measured on the specimen with a Konica Minolta CM-3700D color-difference meter under a SCE condition after exposure under a Method A condition according to ISO 4892-2 for 1,500 hours.

TABLE 2

| | | | | Comp. | Comp. | Comp. | Comp. |
|---|---|---|---|---|---|---|---|
| | Ex. 1 | Ex. 2 | Ex. 3 | Example 1 | Example 2 | Example 3 | Example 4 |
| Izod impact strength | 78.4 | 74.8 | 72.5 | 77.7 | 75.0 | 65.4 | 40.6 |
| (kgf · cm/cm) | | | | | | | |
| dE | 5.0 | 4.8 | 4.6 | 7.4 | 6.9 | 6.8 | 8.0 |

As shown in Table 2, the resin compositions according to Examples 1 to 3 exhibit excellent impact resistance and weather resistance. Specifically, the resin compositions showed Izod impact strength of greater than or equal to 70 kgf·cm/cm, for example, greater than or equal to 72 kgf·cm/cm and as for weather resistance, had dE of less than or equal to 5.0 and thus showed a sharply low color difference compared with the resin compositions of the Comparative Examples.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A resin composition, comprising:
a base resin consisting of (A) a polycarbonate resin and (B) a polybutylene terephthalate resin;
(C) a (meth)acryl-based copolymer; and
(D) high structured carbon black.

2. The resin composition of claim 1, comprising the high structured carbon black in an amount of about 0.1 parts by weight to about 5 parts by weight based on about 100 parts by weight of the base resin consisting of the polycarbonate resin and the polybutylene terephthalate resin.

3. The resin composition of claim 1, comprising the high structured carbon black in an amount of about 0.1 parts by weight to 1 part by weight based on about 100 parts by weight of the base resin consisting of the polycarbonate resin and the polybutylene terephthalate resin.

4. The resin composition of claim 1, wherein the high structured carbon black has an average particle diameter (D50) of primary carbon black particles from about 15 nm to about 25 nm.

5. The resin composition of claim 1, wherein the (meth)acryl-based copolymer includes a methylmethacrylate-butadiene-styrene copolymer.

6. The resin composition of claim 1, comprising the (meth)acryl-based copolymer in an amount of about 1 part by weight to about 10 parts by weight based on about 100 parts by weight of the base resin consisting of the polycarbonate resin and the polybutylene terephthalate resin.

7. The resin composition of claim 1, wherein the base resin includes:
about 50 wt % to about 70 wt % of the polycarbonate resin and about 30 wt % to about 50 wt % of the polybutylene terephthalate resin.

8. An article manufactured from the resin composition of claim 7.

9. The article of claim 8, wherein the article has an Izod impact strength of greater than or equal to about 70 kgf·cm/cm measured on a ⅛″-thick specimen according to ASTM D256.

10. The article of claim 8, wherein the article has a color difference (dE) of less than or equal to about 6 between before and after exposure under a Method A condition according to ISO 4892-2 for 1,500 hours.
